(19) United States
(12) Patent Application Publication
(10) Pub. No.: US 2024/0303827 A1
(43) Pub. Date: Sep. 12, 2024

(54) STATEFUL AND END-TO-END MULTI-OBJECT TRACKING

(71) Applicant: Waymo LLC, Mountain View, CA (US)

(72) Inventors: Longlong Jing, Mountain View, CA (US); Ruichi Yu, Mountain View, CA (US); Xu Chen, Livermore, CA (US); Zhengli Zhao, Sunnyvale, CA (US); Shiwei Sheng, Saratoga, CA (US)

(21) Appl. No.: 18/600,449

(22) Filed: Mar. 8, 2024

Related U.S. Application Data
(60) Provisional application No. 63/450,946, filed on Mar. 8, 2023.

(51) Int. Cl. G06T 7/20; G01S 17/89; G06V 10/44

(52) U.S. Cl. CPC G06T 7/20; G01S 17/89; G06V 10/44; G06T 2207/30241; G06V 2201/07

(57) ABSTRACT

Methods, systems, and apparatus, including computer programs encoded on a computer storage medium, for tracking objects in an environment across time. In one aspect, a method comprises: receiving a set of current object detections, each characterizing features of a respective detected object; maintaining data, including track query feature representations, that identifies one or more object tracks (each associated with respective earlier object detections classified as characterizing the same object; and, for each object track: (i) selecting a subset of the current object detections as candidate object detections for the object track, (ii) generating a respective association score for each candidate object detection based on an input derived from the candidate object detections and the track query feature representation for the object track using a track-detection interaction neural network, and (iii) determining whether to associate any of the current object detections with the object track based on the respective association scores.

### CROSS-REFERENCE TO RELATED APPLICATION

This application claims priority to U.S. Provisional Application No. 63/450,946, filed on Mar. 8, 2023. The disclosure of the prior application is considered part of and is incorporated by reference in the disclosure of this application.

### BACKGROUND

This specification relates to tracking objects in the vicinity of an agent in the environment.

The environment may be a real-world environment, and the agent may be, e.g., a vehicle in the environment.

Tracking objects across time is a task required for motion planning, e.g., by an autonomous vehicle.

Autonomous vehicles include self-driving cars, boats, and aircraft.

Autonomous vehicles use a variety of on-board sensors and computer systems to detect nearby objects and use such detections to make control and navigation decisions, e.g., by predicting the future trajectories of agents in the vicinity of the autonomous vehicles using the detections.

### BRIEF DESCRIPTION OF THE DRAWINGS

FIG. 1 illustrates an example object tracking task.

FIG. 2 is a block diagram illustrating an example object tracking system.

FIG. 3 is a block diagram illustrating an example object detection system.

FIG. 4 is a block diagram illustrating an example track update system.

FIG. 5 is a flow diagram of an example process for object tracking.

FIG. 6 illustrates processing candidate object detections for an object track.

FIG. 7 illustrates associating object detections with an object track.

Like reference numbers and designations in the various drawings indicate like elements.

### DETAILED DESCRIPTION

This specification describes a system implemented as computer programs on one or more computers in one or more locations can track objects in an environment across time.

In particular, this specification describes how a vehicle, e.g., an autonomous or semi-autonomous vehicle, can use an object tracking system to track objects in the vicinity of the vehicle in an environment over time. Tracking objects generally refers to maintaining and updating object tracks across time, with each object track identifying a different object in the vicinity of the vehicle in the environment.

The object tracking data can then be used to make autonomous driving decisions for the vehicle, to display information to operators or passengers of the vehicle, or both. For example, predictions about the future behavior of another object in the environment can be generated based on the object tracking data and can then be used to adjust the planned trajectory, e.g., apply the brakes or change the heading, of the autonomous vehicle to prevent the vehicle from colliding with the other object or to display an alert to the operator of the vehicle.

For example, the object tracking system may be made by an on-board computer system of an autonomous vehicle navigating through the environment and the objects being tracked may be agents that have been detected by the sensors of the autonomous vehicle. The object tracks can then be used by the on-board system to control the autonomous vehicle, i.e., to plan the future motion of the vehicle based in part on the tracked past motion and the likely future motion of tracked objects.

The systems described in this specification generate query representations for object tracks that can be used to both (i) identify object detections that are associated with the corresponding object tacks and (ii) predict states (e.g., velocities, accelerations, headings, control inputs, planned trajectories, etc.) for the objects of the corresponding tracks. Using the query representations for the object tracks, the described systems jointly perform both object tracking and object state prediction.

Conventional methods generally perform object tracking and object state prediction as separate tasks, e.g., by first determining object tracks and by then predicting object states based in the determined object tracks. However, object tracking provides information beneficial for performing object state estimation (e.g., previous locations for an object can aid in predicting a velocity for the object) and state estimation provides information beneficial for performing object tracking (e.g., predicted velocities, accelerations, headings, and so on for an object can aid in determining whether a future object detection is associated with the object).

By jointly performing both object tracking and object state prediction, the described systems can perform both tasks more accurately than conventional methods. Unlike conventional methods, the described systems can utilize the query representation of the object tracks to jointly encode information useful for performing both object tracking and object state prediction. Additionally, by jointly performing object tracking and object state prediction, the described systems can be trained in an end-to-end manner (e.g., trained to perform both tasks at the same time using the same training data), unlike conventional methods, and can have a simplified architecture compared to conventional methods.

Object tracking and object state prediction are key components to performing tasks such as trajectory prediction and navigation planning for controlling autonomous vehicles. By more accurately performing object tracking and object state prediction, the described systems can therefore be used to improve control and navigation planning for autonomous vehicles.

These features and other features are described in more detail below.

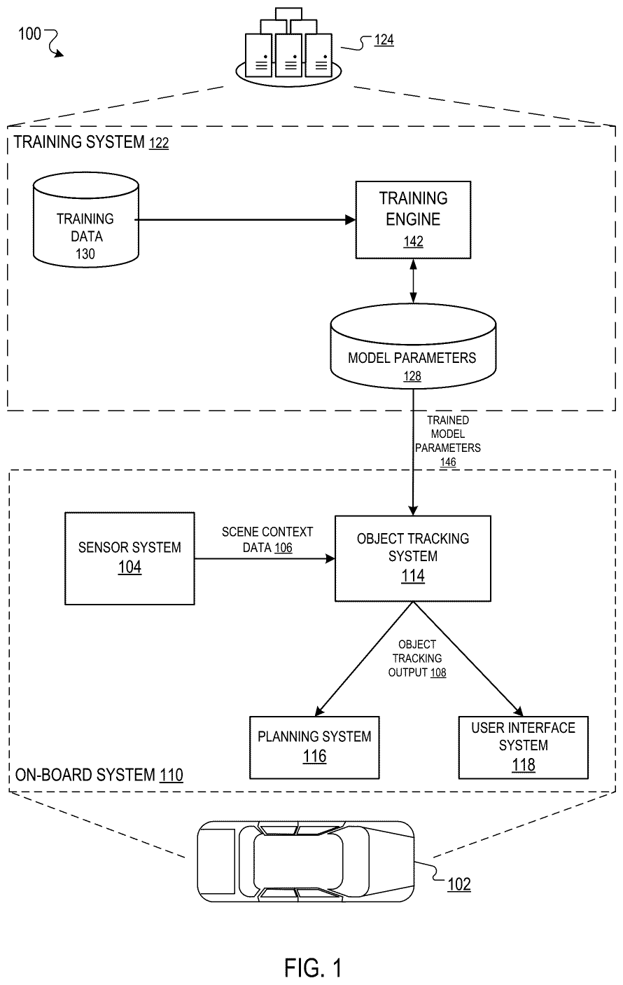

FIG. 1 shows an on-board system 110 for a vehicle 102 that tracks objects in an environment around the vehicle 102.

The on-board system 110 is located on-board the vehicle 102. The vehicle 102 in FIG. 1 is illustrated as an automobile, but the on-board system 110 can be located on-board any appropriate vehicle type.

In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle. As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 102 can alert the driver of the vehicle 102 or take an autonomous driving action when an obstacle is detected, when the vehicle departs from a driving lane, or when an object is detected in a blind spot of the human driver.

The on-board system 110 includes a sensor system 104 which enables the on-board system 110 to “see” the environment in the vicinity of the vehicle 102. More specifically, the sensor system 104 includes one or more sensors, some of which are configured to receive reflections of electromagnetic radiation from the environment in the vicinity of the vehicle 102. For example, the sensor system 104 can include one or more laser sensors (e.g., LIDAR laser sensors) that are configured to detect reflections of laser light. As another example, the sensor system 104 can include one or more radar sensors that are configured to detect reflections of radio waves. As another example, the sensor system 104 can include one or more camera sensors that are configured to detect reflections of visible light.

The sensor system 104 continually (i.e., at each of multiple time points) captures raw sensor data, which can indicate the directions, intensities, and distances travelled by reflected radiation. For example, a sensor in the sensor system 104 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

The on-board system 110 can process the raw sensor data to generate scene context data 106.

The scene context data 106 characterizes a scene in an environment, e.g., an area of the environment that includes the area within a threshold distance of the autonomous vehicle or the area that is within range of at least one sensor of the vehicle.

Generally, the scene context data 106 includes multiple modalities of features that describe the scene in the environment. A modality, as used in this specification, refers to a feature that provides a particular type of information about the environment. Thus, different modalities provide different types of information about the environment. For example, the scene context data 106 can include features from the following modalities: a traffic light state modality that provides information about a traffic light state of traffic lights in the environment, a road graph data modality that provides static information about the roadways in the environment, an agent history modality that provides information about the current and previous positions of agents in the environment, and an agent interaction modality that provides information about interactions between agents in the environment

In some examples, the context data 106 includes raw sensor data generated by one or more sensors from the sensor system 104. In some examples, the context data includes data that has been generated from the outputs of an object detector that processes the raw sensor data from the sensor system 104.

At any given time point, the on-board system 110 can process the scene context data 106 using an object tracking system 114 to track objects (e.g., agents, such as pedestrians, bicyclists, other vehicles, and so on) in the environment in the vicinity of the vehicle 102.

In particular, the on-board system 110 can generate a respective object tracking output 108 for each of one or more target agents in the scene at the given time point. The object tracking output 108 for a target agent specifies observed locations of the target agent at previous time points and can include predicted states of the target agent (e.g., headings, velocities, accelerations, control inputs, intended trajectories, etc.) for each of the previous time points.

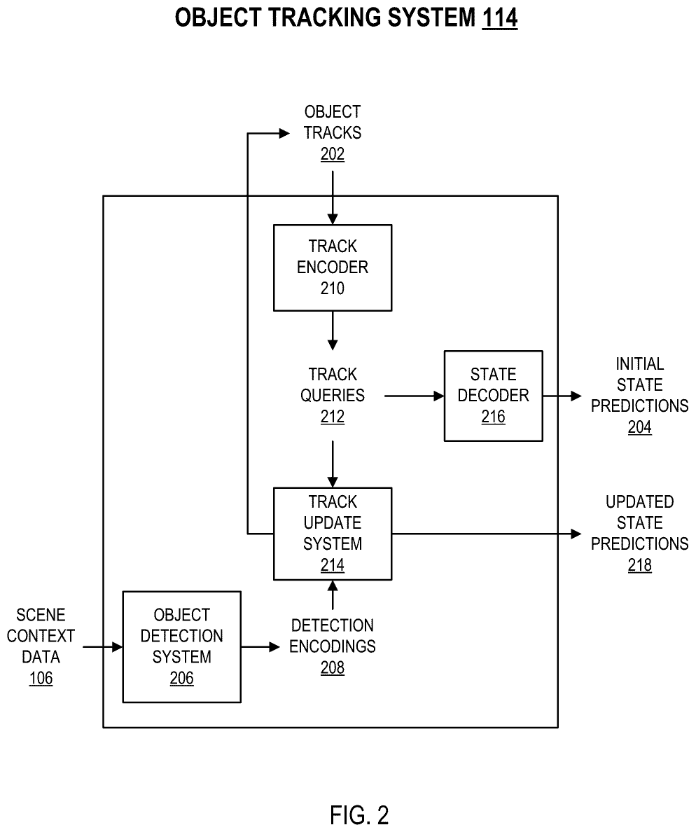

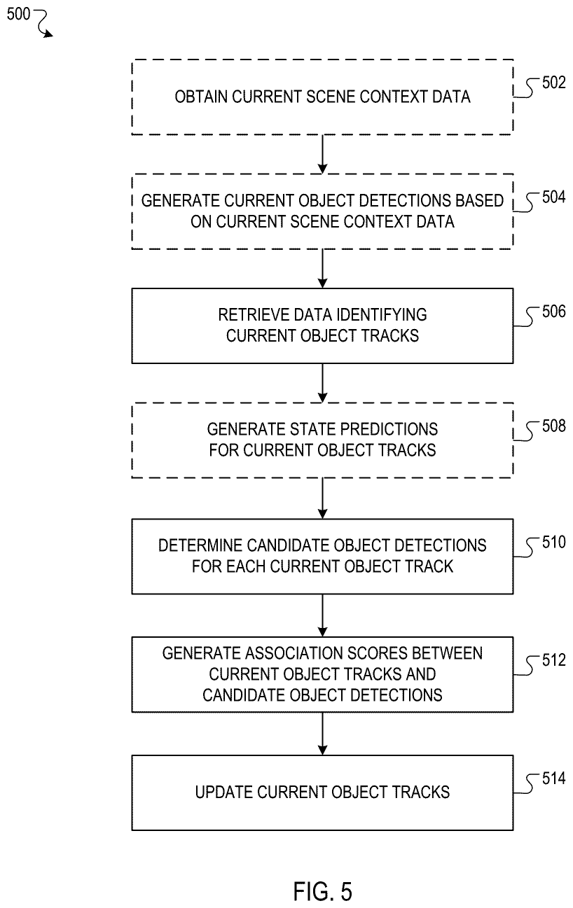

The processing performed by the object tracking system 114 to generate the object tracking output 108 is described in further detail below with reference to FIGS. 2 and 5.

The on-board system 110 can provide the object tracking output 108 generated by the object tracking system 114 to a planning system 116, a user interface system 118, or both.

The on-board system 110 can use the object tracking output 108 as part of predicting trajectories of agents in the vicinity of the vehicle 102.

In particular, when the planning system 116 receives the object tracking output 108, the planning system 116 can use the object tracking output 108 to make fully-autonomous or partly-autonomous driving decisions. For example, the planning system 116 can generate a fully-autonomous plan to navigate the vehicle 102 to avoid a collision with another agent by changing the future trajectory of the vehicle 102 to avoid the predicted future trajectory of the agent. In a particular example, the on-board system 110 may provide the planning system 116 with object tracking output 108 indicating that another vehicle which is attempting to merge onto a roadway being travelled by the vehicle 102 is unlikely to yield to the vehicle 102. In this example, the planning system 116 can generate fully-autonomous control outputs to apply the brakes of the vehicle 102 to avoid a collision with the merging vehicle. The fully-autonomous or partly-autonomous driving decisions generated by the planning system 116 can be implemented by a control system of the vehicle 102. For example, in response to receiving a fully-autonomous driving decision generated by the planning system 116 which indicates that the brakes of the vehicle should be applied, the control system may transmit an electronic signal to a braking control unit of the vehicle. In response to receiving the electronic signal, the braking control unit can mechanically apply the brakes of the vehicle.

When the user interface system 118 receives the object tracking output 108, the user interface system 118 can use the object tracking output 108 to present information to the driver of the vehicle 102 to assist the driver in operating the vehicle 102 safely. The user interface system 118 can present information to the driver of the vehicle 102 by any appropriate means, for example, by an audio message transmitted through a speaker system of the vehicle 102 or by alerts displayed on a visual display system in the vehicle (e.g., an LCD display on the dashboard of the vehicle 102). In a particular example, the on-board system 110 may provide the user interface system 118 with object tracking output 108 indicating that another vehicle which is attempting to merge onto a roadway being travelled by the vehicle 102 is unlikely to yield to the vehicle 102. In this example, the user interface system 118 can present an alert message to the driver of the vehicle 102 with Instructions to adjust the trajectory of the vehicle 102 to avoid a collision with the merging vehicle.

The object tracking system 114 can include one or more object tracking machine learning models configured to perform object tracking. Prior to the on-board system 110 using the object tracking system 114 to make predictions, a training system 122 can determine trained model parameters 146 for the object tracking machine learning models of the system 114.

The training system 122 is typically hosted within a data center 124, which can be a distributed computing system having hundreds or thousands of computers in one or more locations.

The training system 122 can train object tracking machine learning models for the object tracking system 114 using training data 130 of the system 122. The training data 130 generally includes example scene context data 106. The training data 130 may be obtained from real or simulated driving data logs.

The training data 130 can include data from multiple different modalities. In some cases the training data 130 includes raw sensor data generated by one or more sensors, e.g., a camera sensor, a lidar sensor, or both. In other cases, the training data 130 includes data that has been generated from the outputs of an object detector that processes the raw sensor data.

The training engine 142 trains the object tracking machine learning models for the object tracking system 114 to update model parameters 128 by optimizing an objective function based on ground truth object tracks, e.g., an objective function that measures errors between ground truth object tracks and object tracks generated by the object tracking machine learning models, as described in more detail below with reference to FIG. 2.

After training the object tracking machine learning models, the training system 122 can send the trained model parameters 146 to the object tracking system 114, e.g., through a wired or wireless connection.

While this specification describes that the object tracking output 108 is generated on-board an autonomous vehicle, more generally, the described techniques can be implemented on any system of one or more computers that receives images of scenes in an environment. That is, once the training system 122 has trained the object tracking system 114-A, the trained system 114-A can be used by any system of one or more computers.

As one example, the object tracking output 108 can be generated on-board a different type of agent that has sensors and that interacts with objects as it navigates through an environment. For example, the object tracking output 108 can be generated by one or more computers embedded within a robot or other agent.

As another example, the object tracking output 108 can be generated by one or more computers that are remote from the agent and that receive images captured by one or more camera sensors of the agent. In some of these examples, the one or more computers can use the object tracking output 108 to generate control decisions for controlling the agent and then provide the control decisions to the agent for execution by the agent.

As another example, the object tracking output 108 can be generated by one or more computers that are remote from the agent and that receive images captured by one or more camera sensors of the agent. In some of these examples, the one or more computers can use the object tracking output 108 to generate control decisions for controlling the agent and then provide the control decisions to the agent for execution by the agent.

FIG. 2 shows an example object tracking system 114. The object tracking system 114 is an example of a system implemented as computer programs on one or more computers in one or more locations in which the systems, components, and techniques described below are implemented.

At any given time step, the object tracking system 114 can maintain and update data that identifies one or more object tracks 202 through an environment. Each of the object tracks 202 is associated with an object within the environment and includes data that specifies locations of the associated object at one or more earlier time steps that precede the given time step. The object tracking system 114 can perform both object tracking to update the object tracks 202 based on new object detections and object state prediction for the object tracks 202.

The object tracking system 114 can update the object tracks 202 at a given time step by processing scene context data 106 for the given time step. The scene context data 106 for a time step can include data characterizing one or more object detections for the time step. Each object detection for a time step includes data that characterizes an observed location at the time step of an object in the environment. For example, each object detection can specify a position for a respective object at the time step. As another example, each object detection can specify coordinates that define a bounding box for a respective object at the time step.

The object tracking system 114 can update the object tracks 202 at a time step by classifying each of the object detections for the time step as either (i) characterizing a same object in the environment as one of the object tracks 202 or (ii) characterizing a different object in the environment from each of the object tracks 202. When the system 114 classifies an object detection as characterizing a same object as a particular one of the object tracks 202, the system 114 can add the object detection to the particular object track 202. When the system 114 classifies an object detection as characterizing a different object in the environment from each of the object tracks 202, the system 114 can add a new object track 202 that includes the object detection.

The object tracking system 114 can classify whether an object detection characterizes a same object as an object track 202 by determining an association score between the object detection and the object track 202. In particular, the system can determine an association score between an object detection and an object track 202 by processing a detection encoding 208 for the object detection and a track query feature representation 212 for the object track 202. The association score between an object detection and an object track 202 can characterize a likelihood that the object detection and the object track represent the same object (e.g., a higher association score can indicate that the object detection is more likely to represent the same object as the object track).

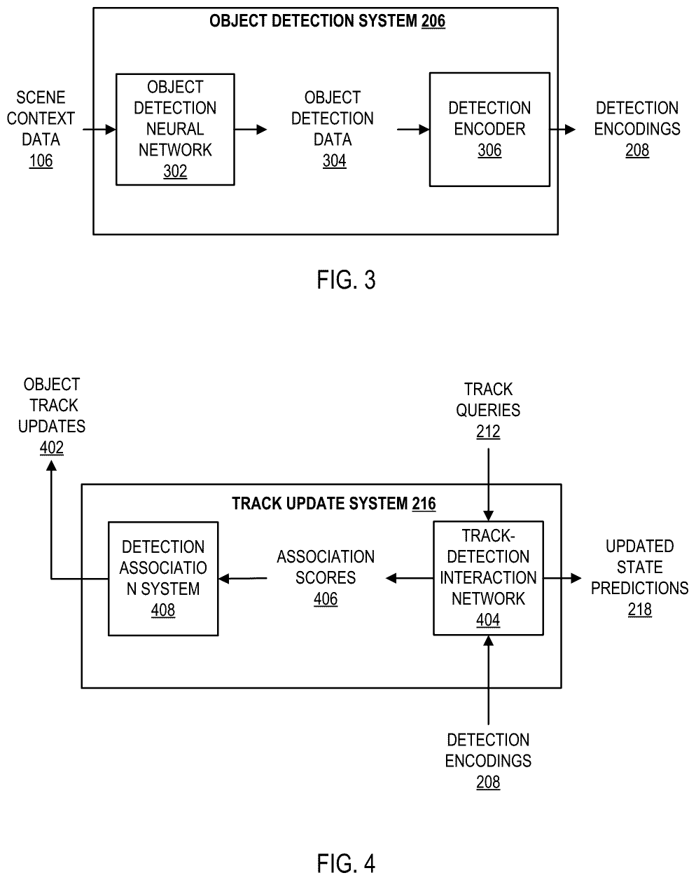

The detection encoding 208 for an object detection is a numerical representation of the object detection that characterizes an observed state of the detected object (e.g., a position, a heading, an orientation, an appearance, etc.) based on the scene context data 106. The system 114 can include an object detection system 206 configured to generate the detection encodings 208 for the objects represented by the scene context data 106. An example object detection system 206 is described in more detail below with reference to FIG. 3.

Similarly, the track query feature representation 212 for an object track 202 is a numerical representation of the object track 202 that characterizes states of the object (e.g., positions, headings, orientations, velocities, headings, appearances, etc.) for the object track 202 at previous time points. The system 114 includes a track encoder 210 configured to generate the track query feature representations 212 by processing the object tracks 202. The system 114 trains the track encoder 210 to generate query feature representations 212 that can be used to perform both object tracking and object state prediction for the object tracks 202.

The track encoder 210 can be a neural network with any neural architecture suited to producing track query feature representations 212 of the object tracks. For example, the track encoder 210 can be a temporal fusion neural network with a Transformer architecture configured to process the detection encodings 208 of the object detections within a given object track 202 to generate the track query feature representation 212 of the given object track 202. When the track encoder 210 is a temporal fusion neural network, the track encoder 210 can use temporal attention over the object detections of the object track 202 to encode changes in the object track 202 over time within the track query feature representation 212.

The object tracking system 114 includes a track update system 214 that is configured (i) to process the detection encodings 208 and the track query feature representations 212 to determine the association scores between the corresponding object detections and object tracks and (ii) update the object tracks 202 as described above based on the determined association scores. An example track update system 214 is described in more detail below with reference to FIG. 4.

An example process for performing object tracking using the object tracking system 114 is described in more detail below with reference to FIG. 5.

The object tracking system 114 can use the track query feature representations 212 to generate initial state predictions 204 for the objects. As an example, the initial state predictions 204 at a given time step can include predicted headings, orientations, velocities, headings, etc., for the objects associated with the object tracks 202 based on the object detections at previous time steps. As another example, the initial state predictions 204 can include predicted control inputs at the given time step for the objects associated with the object tracks 202 based on the object detections at previous time steps. As another example, the initial state predictions 204 can include predicted trajectories (e.g., predicted locations for future time steps after the given time step) for the objects associated with the object tracks 202 based on the object detections at previous time steps. As another example, the initial state predictions 204 can include predicted object types (e.g., pedestrian, cyclist, automobile, etc.) and predicted object attributes (e.g., object mass).

The system can include a state decoder 216 configured to process the track query feature representations 212 and generate the corresponding initial state predictions 204 for the associated objects. As an example, the state decoder 216 can be a feed forward neural network trained by optimizing a prediction loss for the initial state predictions 204.

The track update system can generate updated state predictions 218 based on the track query feature representations 212 and the detection encodings 208. As an example, the updated state predictions 218 at a given time step can include predicted headings, orientations, velocities, headings, etc., for the objects associated with the object tracks 202 based on the object detections as of the given time step. As another example, the updated state predictions 218 can include predicted control inputs at the given time step for the objects associated with the object tracks 202 based on the object detections as of the given time step. As another example, the updated state predictions 218 can include predicted trajectories (e.g., predicted locations for future time steps after the given time step) for the objects associated with the object tracks 202 based on the object detections as of the given time step.

In general, the object tracking system 114 can be trained end-to-end (e.g., the component machine learning models of the system 114 can be trained jointly using the same objective function and training data) using an objective function that measures both (i) an assignment error that encourages the system 114 to correctly assign object detections to object tracks 202 and (ii) a prediction error that encourages the system 114 to generate accurate initial state predictions 204. As an example, for the i-th object track and at a time step t, the objective function can measure the loss:

$${ℒ}_{i} = α {L}_{d , i} + β {L}_{s , i}^{t - 1} + γ {L}_{s , i}^{t}$$

Where α, β, and γ denote scaling constants, L_{s,i}^{t-1} measures a state prediction error before updating the i-th object track for the time step t, L_{s,i}^{t} a measures a state prediction error after updating the i-th object track for the time step t, and L_{d,i} measures an assignment error for the i-th object track at the time step t.

For example, the assignment error, L_{d,i}, can be determined following:

$${L}_{d , i} = {\sum }_{j} - {y}_{i , j} log {A}_{i , j} - ( 1 - {y}_{i , j} ) log ( 1 - {A}_{i , j} )$$

Where A_{i,j} denotes the assignment score between the i-th object track and the j-th candidate object detection for the i-th object track and y_{i,j} denotes a ground truth assignment between the i-th object track and the j-th candidate object detection (e.g., y_{i,j}=1 when the j-th candidate object detection is to be associated with the i-th object track and y_{i,j}=0 otherwise).

The state prediction errors, L_{s,i}^{t-1} and L_{s,i}^{t}, can be determined following:

$${L}_{s , i}^{t - 1} = \vert {S}_{i , t - 1} - {S}_{i , t - 1}^{*} \vert \\ {L}_{s , i}^{t} = \vert {S}_{i , t} - {S}_{i , t}^{*} \vert$$

Where S_{i,t} denotes a state prediction 204 generated by the object tracking system 114 based on the i-th object track after time step t and S*_{i,t} denotes a corresponding ground truth state for the i-th object track after time step t (e.g., S_{i,t-1} denotes the initial state prediction 204 generated based on the i-th object track with object detections as of time step t−1 and S_{i,t} denotes the updated state prediction 218 generated while updating the i-th object track with object detections from time step t).

By optimizing an objective function that includes both an assignment error and a state prediction error, the object tracking system 114 can be trained to perform both object tracking and object state prediction. In particular, optimizing a combination of the assignment error and the state prediction error encourages the track query feature representations 212 to encode information useful for performing both object tracking and object state prediction.

FIG. 3 shows an example object detection system 206 that can process scene context data 106 and generate detection encodings 208 that represent detected objects within the scene context data 106.

The object detection system 206 can include an object detection neural network 302 configured to process the scene context data 106 and generate object detection data 304.

The object detection neural network 302 can have any of a variety of neural architectures suited to detecting and locating objects within the scene context data 106. For example, the object detection neural network 302 can be configured to detect objects within the scene context data 106 and predict bounding boxes (e.g., predict locations, sizes, orientations, etc., for the bounding boxes) for the detected objects. When the scene context data 106 includes images, the object detection neural network 302 can include neural networks suited to processing image data (e.g., convolutional neural networks, vision Transformers, etc.). When the scene context data 106 includes point cloud data, the object detection neural network 302 can include neural networks suited to processing point cloud data (e.g., graph neural networks, Transformers, etc.).

The object detection data 304 can include geometry features for each of the detected objects that characterize locations of the detected objects within the environment. For example, the geometry features can include locations, sizes, orientations, etc., for bounding boxes determined for the detected objects.

The object detection data 304 can also include appearance features that characterize the scene context data 106 associated with the detected objects. As an example, the appearance features can include images of the detected objects, point clouds for the detected objects, etc., from the scene context data 106. As another example, the appearance features can data generated by feature extraction neural networks processing scene context data 106 associated with the detected objects. For example, the appearance features can include network outputs from image processing neural networks (e.g., convolutional neural networks, vision transformers, etc.) as applied to images of the detected objects from the scene context data 106. As another example, the appearance features can include network outputs from point cloud processing neural networks (e.g., three dimensional convolutional neural networks, graph neural networks, etc.) as applied to points clouds for the detected objects from the scene context data.

When the scene context data 106 includes data that measures motions of objects within the environment (e.g., Doppler data), the object detection data 304 can include motion features that include data from the scene context data 106 and characterize motions of the detected objects.

The object detection system 206 can include a detection encoder 306 configured to process the object detection data 304 and generate the corresponding detection encodings 208 for the detected objects. In particular the detection encoder 206 can be a neural network with any suitable architecture for processing the object detection data 304. For example, the detection encoder 206 can be a feed-forward neural network configured to process concatenated network inputs that include the geometry, appearance, motion, etc., features of the detected objects from the object detection data 304.

FIG. 4 shows an example track update system 216 that can process detection encodings 208 for detected objects and track query feature representations 212 and determine object track updates 402.

The track update system 216 can include a track-detection interaction neural network 404 that can determine association scores 406 between the track query feature representations 212 and the detection encodings. The track-detection interaction neural network 404 can have any neural architecture suited to computing association scores 406 between the track query feature representations 212 and the detection encodings 208. For example, track-detection interaction neural network 404 can be a Transformer model that determines the association scores 406 by applying an attention mechanism between the track query feature representations 212 and the detection encodings 208 (e.g., by processing the track query feature representations 212 as queries and the detection encodings 208 as keys for the Transformer model).

The association score 406 for a detection encoding 208 and track query feature representation 212 can characterize a likelihood that the detection encoding 208 represents the same object as the track query feature representation.

The track-detection interaction neural network 404 can generate updated state predictions 218 based on the track query feature representations 212 and the detection encodings 208. In particular, the track-detection interaction neural network 404 can generate track embeddings by cross attending the track query feature representations 212 with the detection encodings 208 and process the track embeddings using a feed-forward neural network to generate the updated state predictions 218.

Rather than determining an association score 406 for each combination of track query feature representation 212 and detection encoding 208, the track update system 216 can determine a set of candidate objects for each of the object tracks of the track query feature representations 212 and determine the association scores 406 between the track query feature representations 212 and the detection encodings 208 for the corresponding candidate objects. For example, the candidate objects for an object track at a given time step can be the object detections within a neighborhood (e.g., within a pre-determined distance threshold) of a position for the object track at the given time step. As an example, the position for the object track at the given time step can be a position of a most recent object detection for the object track. As another example, the position for the object track at the given time step can be a predicted position based previous object detections for the object track. As a further example, the position for the object track at the given time step can be a predicted position included within a state prediction generated from the track query feature representation 212 for the object track.

When the system generates state predictions based on the track query feature representations 212, the track update system 216 can use the state predictions as part of calculating the association scores 206.

The track update system 216 can use the state predictions to select the candidate detections for the object track. For example, when the state predictions include predicted locations for the object tracks, the track update system 216 can use the predicted locations to specify the neighborhoods for the object tracks that determine the candidate objects for the object tracks (e.g., by centering the neighborhoods for the object tracks on the predicted locations for the object tracks).

The track update system 216 can use the predicted locations to weight the association scores 406 (e.g., by increasing association scores 206 for candidate objects closer to the predicted locations for the object tracks).

The track update system 216 includes a detection association system 408 that can generate object the track updates 402 based on the association scores 406. In general, the detection association system 408 associates objects to object tracks by processing the association scores 406 using a matching algorithm.

For example, the detection association system 408 can use a greedy matching algorithm, which matches the object and object track having the highest association score 406 at each of a sequence of matching steps (removing the matched object and object track from the association scores for future matching steps) until either (i) no objects remain to be matched, (ii) no object tracks remain to be matched, or (iii) all of the remaining association scores 406 fall below a pre-determined score threshold.

As another example, the detection association system 408 can apply a Hungarian matching algorithm to the association scores 406 to match the objects with the object tracks, as described by Harold Kuhn in “The Hungarian Method for the Assignment Problem”.

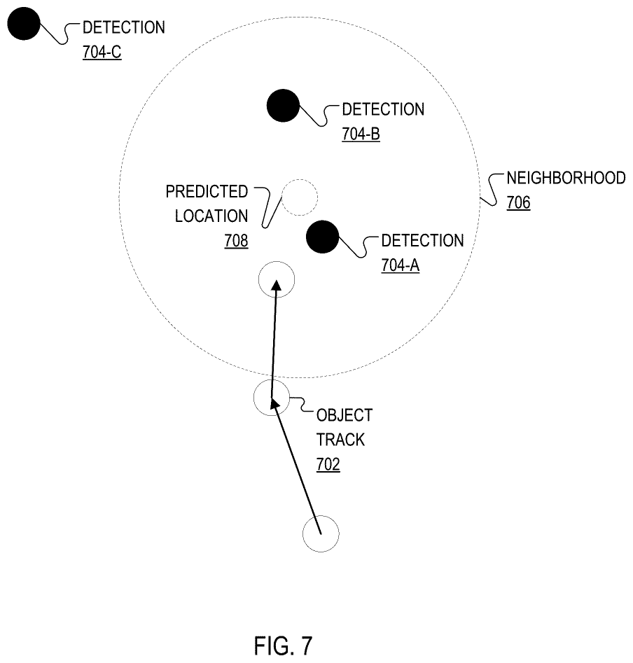

An illustrated example of associating object detections with object tracks is described in more detail below with reference to FIG. 7.

FIG. 5 is a flow diagram of an example process for object tracking. For convenience, the process 500 will be described as being performed by a system of one or more computers located in one or more locations. For example, a training system, e.g., the object tracking system 114 of FIG. 1, appropriately programmed in accordance with this specification, can perform the process 500.

In some implementations, the system can obtain scene context data for the current time step (step 502). The scene context data can include data collected by sensors in a real-world environment. For example, the scene context data can include images collected by cameras, radar data collected by RADAR sensors, laser sensor spin data collected by LIDAR sensors, and so on.

When the system obtains scene context data for the current time step, the system can generate a set of current object detections for the current time step based on the scene context data (step 504). Each current object detection can be data characterizing features of a respective object that has been detected (e.g., detected within the current scene context data) in an environment at the current time step.

The system can generate the set of current object detections by applying an object detection model to the scene context data. For example, when the scene context data includes image data, the system can apply 2D object detection models to the image data. As another example, when the scene context data includes point cloud data, the system can apply 3D object detection models to the point cloud data.

The object detections can include geometry features for each of the detected objects that characterize locations of the detected objects within the environment. For example, the geometry features can include locations, sizes, orientations, etc., for bounding boxes determined for the detected objects.

The object detections can also include appearance features that characterize the scene context data associated with the detected objects. For example, the appearance features can include images of the detected objects, point clouds for the detected objects, etc., from the scene context data.

When the scene context data includes data that measures motions of objects within the environment (e.g., Doppler data), the object detection data can include motion features that include data from the scene context data and characterize motions of the detected objects.

In some implementations, rather than processing scene context data to generate the object detections for the current time step, the system can receive data that specifying the object detections for the current time step from another system.

The system can generate embeddings of the current object detections by processing each object detection using a detection encoder.

The system can retrieve data specifying object tracks for previously tracked objects (step 506). In general, the system maintains data that identifies one or more object tracks. Each of the object tracks is associated with one or more respective object detections from previous time steps that the system has classified as characterizing the same object.

The system can generate a track query feature representation for each of the one or more object tracks.

In particular, for each of the object tracks, the system can process the embeddings of the detections in the object track using a temporal fusion neural network to generate the query feature representation for the object track.

In some implementations, the system can generate a updated state prediction for each of the object tracks (step 508). In particular, the system can process the track query feature representation of each object track using a track state decoder neural network to generate a predicted state of the object track at the current time point.

As an example, the state predictions for the object tracks can include predicted positions, headings, orientations, velocities, headings, etc., for the objects associated with the object tracks. As another example, the state predictions for the object tracks can include predicted control inputs for the objects associated with the object tracks. As another example, the state predictions for the object tracks can include predicted trajectories for the objects associated with the object tracks. As another example, the state predictions can include predicted object types (e.g., pedestrian, cyclist, automobile, etc.) and predicted object attributes (e.g., object mass).

The system can determine candidate object detections for each of the object tracks (step 510). As an example, the system can specify neighborhoods for each of the object tracks and can determine that an object detection within the neighborhood of an object track is a candidate object detection for the object track.

In some implementations, the system can use the predicted states of the object tracks to select the candidate detections for the object tracks. For example, the system can determine the neighborhoods for the object tracks based on the predicted states for the object tracks. As a further example, the system can determine the neighborhoods for the object tracks based on predicted locations for the object tracks (e.g., by centering the neighborhoods on the predicted locations).

For each object track, the system can generate association scores between the object track and each candidate object detection for the object track (step 512). In particular, for each object track, the system can process the candidate object detections for the object track and the track query feature representation for the object track using a track-detection interaction neural network to generate a respective association score between each candidate object detection and the object track. In some implementations, the track-detection interaction neural network can process the embeddings of candidate object detections and the track query feature representations for object tracks to generate the respective association scores.

The system can then use the generated association scores to update the object tracks for the current time step (step 514). In particular, for each of the object tracks, the system can determine whether to associate any of the current object detections with the object track based on the respective association scores for the object track.

In some implementations, the system can apply a Hungarian matching algorithm to the association scores to assign each object detection for the current time step either (i) to one of the object tracks or (ii) to a new object track. When the system assigns an object detection to a new object track, the system can add the new object track to the maintained data identifying the object tracks for the system.

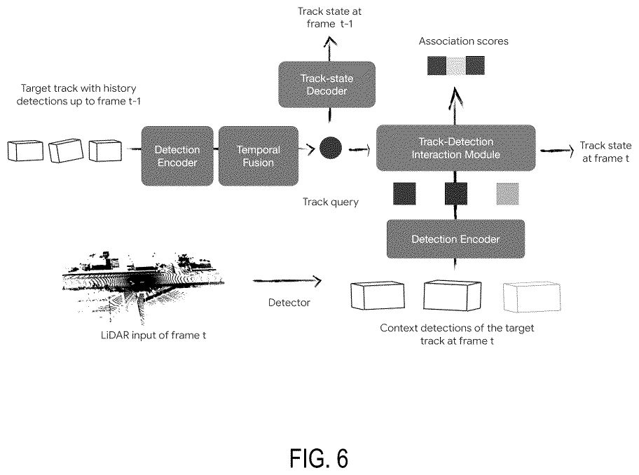

FIG. 6 illustrates processing candidate object detections for a target object track at a time step t.

As illustrated, the target object track includes previous object detections for the target object (e.g., object detections for the target object through the previous time step, t−1). The system can process the target object track using temporal fusion to generate a track query representation of the target track. In particular, the system can perform temporal fusion of encodings of the object detections within the target object track, as generated by a detection encoder of the system, to generate the track query representation.

The track query representation can be used to perform both object state prediction and object tracking for the target object track. To perform object state prediction using the track query representation, the system can process the track query representation using a track state decoder of the system to generate a prediction for the object state as of the time step t−1.

To perform object tracking, the system can receive scene context data (e.g., LIDAR point cloud data, as illustrated in FIG. 7) for the timestep t. The system can process the scene context data to identify a set of object detections for the timestep t. The system can then determine a set of candidate object detections (e.g., context detections) for the target object track. An example of determining candidate object detections for an object track is described below with reference to FIG. 7.

The system can encode the candidate object detections for the target object track using the detection encoder.

The system can then process the track query representation and the encoded candidate object detections for the target object track using a track-detection interaction system to generate association scores between the target object track and each of the candidate object detections for the target object track. The system can then use the association scores to determine whether to add one of the candidate object detections to the target object track. In some situations (e.g., when the association scores all fall below a particular threshold), the system may assign none of the candidate object detections to the target object track. Otherwise, the system assigns one of the candidate object detections to the target object track (e.g., the system may assign the candidate object detection having the largest association score to the target object track).

The system can also generate an object state prediction for the target object track as of the time step t based on the output of the track-detection interaction system.

FIG. 7 illustrates associating object detections with an example object track 702 for a time step.

At the illustrated time step, the system receives object detections 704-A, 704-B, and 704-C. The system determines candidate object detections for the object track 702. As illustrated, the system can determine the candidate object detections based on which of the object detections 704-A, 704-B and 704-C are located within a neighborhood 706 for the object track 702. For example, as illustrated, the system can determine that object detections 704-A and 704-B are candidate object detections for the object track 702 at the illustrated time step.

The system can determine the candidate detections for the object track 702 based on state predictions for the object track 702. For example, the state predictions for the object track 702 can include a predicted location 708 for the track 702, and the system can determine the neighborhood 706 using the predicted location 708 (e.g., by centering the neighborhood 706 on the predicted location 708).

The system can then determine association scores between the object track 702 and the candidate object detections 704-A and 704-B. Based on the association scores, the system may add one of the object detections 704-A or 704-B to the object track 702. For example, if the system does not assign object detection 704-A to another object tack and if the association score between the object detection 704-A and the object track 702 exceeds a predetermined threshold, the system can add the object detection 704-A to the track 702.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, at a current time step, a set of new object detections, each new object detection being data characterizing features of a respective object that has been detected in an environment at the current time step;
maintaining data that identifies one or more object tracks;
for each object track, selecting a subset of the new object detections as candidate object detections for the object track;
for each object track, processing an input derived from the candidate object detections for the object track and a track query feature representation for the object track using a track-detection interaction neural network to generate a respective association score for each candidate object detection; and
determining, for each of the one or more object tracks, whether to associate any of the new object detections with the object track based on the respective association scores for the candidate object detections for the object tracks.

2. The method of claim 1, further comprising:
receiving a laser sensor spin at the current time step; and
applying a 3D objection detection model to the laser sensor spin to generate the set of one or more new object detections.

3. The method of claim 1, wherein the features comprise geometry and appearance features of the respective object.

4. The method of claim 1, wherein determining, for each of the one or more object tracks, whether to associate any of the new object detections with the object track based on the respective association scores for the candidate object detections for the object tracks comprises:
applying a Hungarian algorithm to the respective association scores for the candidate object detections for the object tracks to assign each new object detection to one of the object tracks or to a new object track.

5. The method of claim 4, further comprising:
in response to determining to assign a given new object detection to a new object track, adding the new object track to the maintained data.

6. The method of claim 1, further comprising:
processing each new object detection using a detection encoder to generate an embedding of the new object detection.

7. The method of claim 6, wherein the input derived from the candidate object detections for the object track and the track query feature representation for the object track comprises the embeddings of the candidate object detections for the object track and the track query feature representation for the object track.

8. The method of claim 6, further comprising:
generating a new query feature representation for each object track by processing an input comprising respective embeddings of detections that have been associated with the object track using a temporal fusion neural network.

9. The method of claim 1, further comprising:
processing the feature representation of each object track using a track state decoder neural network to generate a predicted state of the object track at the current time point.

10. The method of claim 9, further comprising:
for each object track, using the predicted state of the object track to select the candidate detections for the object track.

11. A system comprising:
one or more computers; and
one or more storage devices storing instructions that, when executed by the one or more computers, cause the one or more computers to perform operations comprising:
receiving, at a current time step, a set of new object detections, each new object detection being data characterizing features of a respective object that has been detected in an environment at the current time step;
maintaining data that identifies one or more object tracks;
for each object track, selecting a subset of the new object detections as candidate object detections for the object track;
for each object track, processing an input derived from the candidate object detections for the object track and a track query feature representation for the object track using a track-detection interaction neural network to generate a respective association score for each candidate object detection; and
determining, for each of the one or more object tracks, whether to associate any of the new object detections with the object track based on the respective association scores for the candidate object detections for the object tracks.

12. The system of claim 11, the operations further comprising:
receiving a laser sensor spin at the current time step; and
applying a 3D objection detection model to the laser sensor spin to generate the set of one or more new object detections.

13. The system of claim 11, wherein the features comprise geometry and appearance features of the respective object.

14. The system of claim 11, wherein determining, for each of the one or more object tracks, whether to associate any of the new object detections with the object track based on the respective association scores for the candidate object detections for the object tracks comprises:
applying a Hungarian algorithm to the respective association scores for the candidate object detections for the object tracks to assign each new object detection to one of the object tracks or to a new object track.

15. The system of claim 14, the operations further comprising:
in response to determining to assign a given new object detection to a new object track, adding the new object track to the maintained data.

16. The system of claim 11, the operations further comprising:
processing each new object detection using a detection encoder to generate an embedding of the new object detection.

17. The system of claim 16, wherein the input derived from the candidate object detections for the object track and the track query feature representation for the object track comprises the embeddings of the candidate object detections for the object track and the track query feature representation for the object track.

18. The system of claim 16, the operations further comprising:
generating a new query feature representation for each object track by processing an input comprising respective embeddings of detections that have been associated with the object track using a temporal fusion neural network.

19. The system of claim 11, the operations further comprising:
processing the feature representation of each object track using a track state decoder neural network to generate a predicted state of the object track at the current time point.

20. One or more computer-readable storage media storing instructions that when executed by one or more computers cause the one or more computers to perform operations comprising:
receiving, at a current time step, a set of new object detections, each new object detection being data characterizing features of a respective object that has been detected in an environment at the current time step;
maintaining data that identifies one or more object tracks;
for each object track, selecting a subset of the new object detections as candidate object detections for the object track;
for each object track, processing an input derived from the candidate object detections for the object track and a track query feature representation for the object track using a track-detection interaction neural network to generate a respective association score for each candidate object detection; and
determining, for each of the one or more object tracks, whether to associate any of the new object detections with the object track based on the respective association scores for the candidate object detections for the object tracks.
